(19) United States
(12) Patent Application Publication
(10) Pub. No.: US 2007/0005398 A1
(43) Pub. Date: Jan. 4, 2007

(54) SYSTEM FOR OBTAINING PATIENT CONSENT

(76) Inventors: Chakravarthy Srinivasa Kalyan Toleti, Windermere, FL (US); Rajesh Srinivasa Kanaka Toleti, Windermere, FL (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/424,983

(22) Filed: Jun. 19, 2006

Related U.S. Application Data
(60) Provisional application No. 60/695,345, filed on Jun. 30, 2005.

(51) Int. Cl. G06F 19/00

(52) U.S. Cl. 705/3

(57) ABSTRACT

A system for obtaining patient consent which includes a kiosk for determining a necessary consent form, for obtaining the necessary consent form, and for recording the consent.

This invention describes a system for obtaining patient consent. Patient consent is needed in healthcare industry in several contexts, including patient encounters with providers, for performing tests at laboratories, for transferring patient health information, etc. Patient consent records a patients agreement to the contents of the consent. Our invention provides a system for obtaining and managing patient consent. The system includes a consent database to track previously obtained consent information and an engine to determine the additional consent needed from a patient. The system enables a healthcare provider to obtain patient consent on an as needed basis.

### SUMMARY OF THE INVENTION

Our invention consists of a system for obtaining and managing the patient consent information. The system includes a consent database to track previously obtained consent information and an engine to determine additional consent needed from a patient for a scheduled encounter. The system enables a healthcare provider to obtain patient consent associated with an encounter. The system determines the additional consent needed based on previous consent, the scheduled encounter, the diagnostic codes, the procedure codes, the practices of the provider, the regulations and several other factors. The system supports digital as well as web based and paper based methods for presenting and signing the consent. The consent obtained is stored digitally and is available for recall on an as needed basis.

### BACKGROUND

Patient consent is needed in several contexts in healthcare industry. Providers of healthcare may need to gather information, submit information, perform tests, perform procedures, and give treatments. An interaction between is the patient and the provider is broadly called an encounter. The type of consent and even the number of consents required varies based on the specific context of an encounter. Obtaining the correct consent is important for regulatory and legal reasons.

As an example, let us consider the case of a patient going to a hospital for an appendectomy. The hospital obtains consent from the patient expressing that the patient has read and understood the risks and the outcomes associated with an appendectomy and releasing the hospital from certain liabilities and acts of god. The record of a patients signature on a consent form is kept by the hospital during the appendectomy and for several years beyond.

Another example of patient consent occurs when a patient is referred to a radiology department for an x-ray by a doctor. The doctor originating the referral is called the referring physician or the referring provider. The doctor, the laboratory or the hospital receiving the referral is called the referred provider. The referring provider needs to obtain patient consent in order to transfer any health record or health information of the patient to the referred provider. The referred provider needs to obtain the patient consent in order to take an x-ray. The referred provider also needs to obtain another patient consent in order to disclose the x-ray to the referring provider. In this example, three different consents need to be obtained from the patient, at various points of care.

A third example is that of a job applicant undergoing a drug test for a prospective employer. The test is often administered by a third party laboratory. The laboratory needs to obtain a consent from the job applicant in order to perform the drug test and it needs to obtain a second consent in order to disclose the result of the test to the prospective employer. The second consent may specify what can be disclosed. In certain cases, only whether the result is positive or negative may be disclosed. In certain other cases, the specific tests and the level of specific drugs found may be disclosed.

There are several more interesting cases of patient consent in health care industry and in other fields related to health care. Our invention applies to such cases as well, besides the specific examples we present in the field of healthcare.

### BRIEF DESCRIPTION OF THE DRAWINGS

FIG. 1 illustrates the preferred embodiment of our invention, where the patient consent is recorded at a kiosk at the provider office.

FIG. 2 illustrates the flow chart for obtaining consent from the patient in FIG. 1.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, aspects of the present invention may be embodied as a method, data processing system, or computer program product. Accordingly, aspects of the present invention may take the form of an entirely software embodiment or an embodiment combining software and hardware aspects, all generally referred to herein as a device. Furthermore, elements of the present invention may take the form of a computer program product on a computer-usable storage medium having computer-usable program code embodied in the medium. Any suitable computer readable medium may be utilized, including hard disks, CD-ROMs, optical storage devices, flash RAM, transmission media such as those supporting the Internet or an intranet, or magnetic storage devices.

Computer program code for carrying out operations of the present invention may be written in an object oriented programming language such as Java®, Python, C# or C++, or in conventional procedural programming languages, such as the “C” programming language, Basic or Perl. The program code may execute entirely on the user's computer, partly on the user's computer, as a stand-alone software package, partly on the user's computer and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks, and may operate alone or in conjunction with additional hardware apparatus described herein.

The preferred embodiment of the present invention will now be described with reference to the figures in which like numbers correspond to like references throughout.

The preferred embodiment of our invention consists of a backend consent database and a customer value management (CVM) system, hooked up to a front-end kiosk at a providers office The patient registers at the kiosk to begin an encounter. After identifying the patient, the backend CVM runs the rule engine to determine the additional consent needed from the patient. This is presented to the patient and the patient is prompted to sign the consent. The consent may be signed by several means. A simple mechanism is a yes/no prompt on the kiosk screen. A more sophisticated mechanism is digital signature capture by means of a signature digitizing device on the kiosk. Another mechanism is printing the consent form at the kiosk, letting the patient sign it and feed it back into the kiosk for scanning. Regardless of the method of signing, the consent obtained is digitally stored in the consent database and the consent event is recorded in the CVM system.

A key benefit of our invention is the ability to obtain necessary patient consent at various points of care based on specific contexts. This provides tremendous improvement over the current practice of manually obtaining consent on paper, which is laborious, expensive, slow and difficult to track.

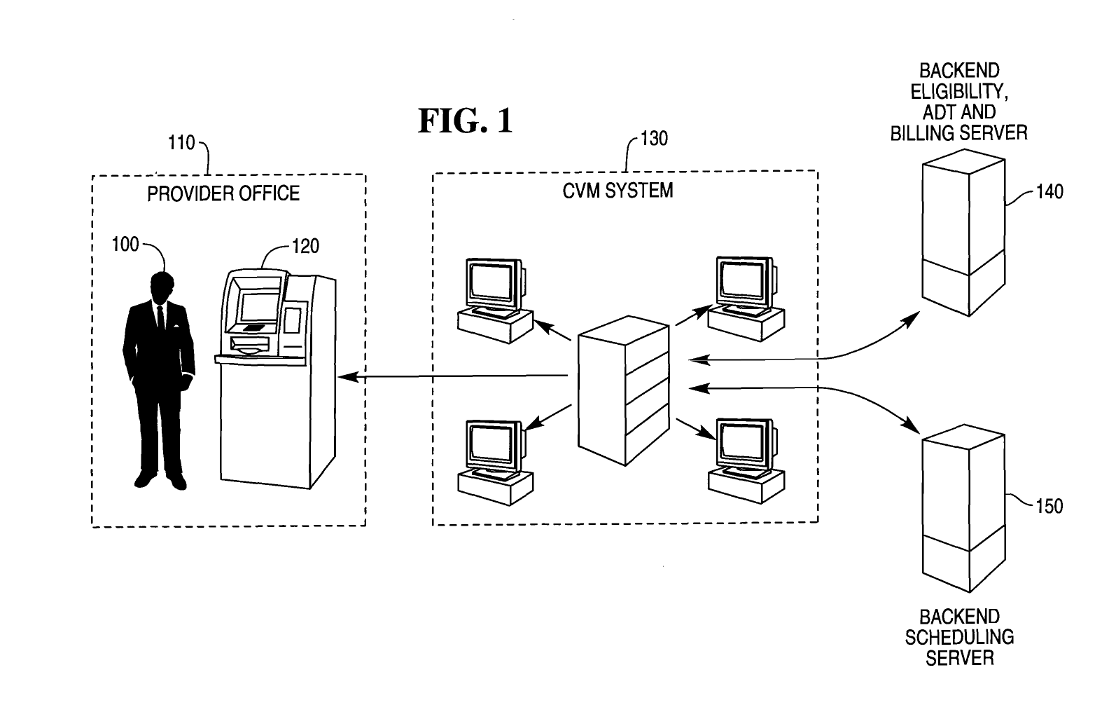

We illustrate the working of our system in FIG. 1. Patient 100 is visiting provider office 110 for a flu shot. The patient “checks in” at kiosk 120. The kiosk contacts the CVM system 130 in order to identify the patient. The CVM system in turn contacts the providers backend eligibility, ADT and Billing applications 140. After identifying the patient and verifying their eligibility and related details, the CVM system contacts the scheduling system 150 and infers that the patient is visiting for a flu shot. The CVM system presents information on the flu shot to the patient at the kiosk and prompts for consent. It records the patients answer in its consent store or database.

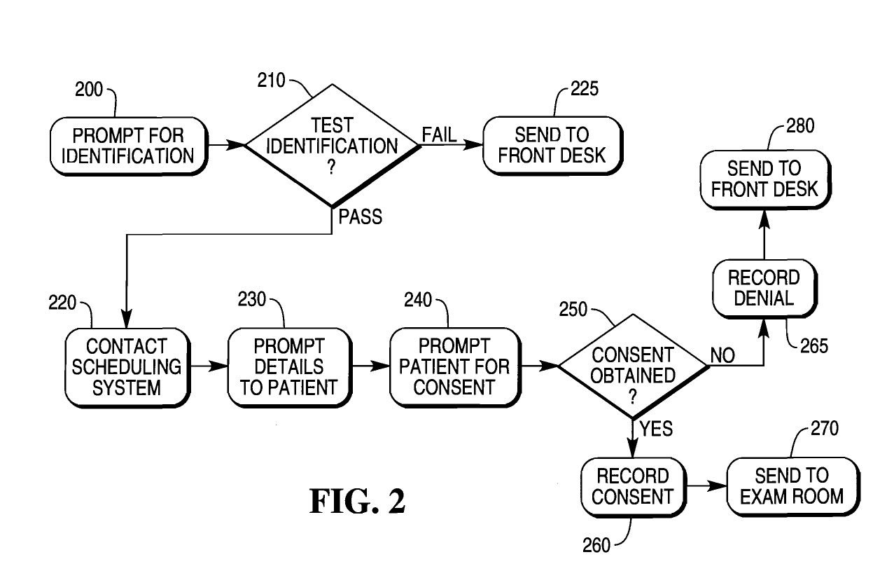

We further illustrate the flow of events of FIG. 1 in the flow chart of FIG. 2. The patient of FIG. 1 is prompted for identification in step 200 of FIG. 2. The identification test is performed in step 210, where the CVM system contacts the backend eligibility system. If the identification is positive, then step 220 is executed. Other wise the patient is prompted to see the front desk personnel in step 225. In step 220, the CVM system contacts the backend scheduling system and retrieves that the patient is scheduled for a flu shot. It infers that the patient needs to be presented with specific details of the flu shot and then prompted for consent. The patient is presented with detailed information on the flu shot in step 230. The patient is asked for consent in step 240. Step 250 checks whether the patient agrees to provide consent or denies the consent. If the patient provides the consent, this is recorded in step 260 and the patient is sent to the examination room in step 270. If the patient denies the consent, this is recorded in step 265 and the patient is sent to see the front desk in step 280.

We described a specific embodiment of the invention along with specific examples in the specific domain of healthcare. Practitioners of the art can apply our invention to several other examples, that may differ in several ways from the examples we discussed, including but not limited to the type of encounter, the type of appointment or procedure, the details of the information/consent, etc. Practitioners of the art can derive several embodiments and domains of applicability of our invention. An alternate embodiment of the invention may not use a kiosk. Yet another alternate embodiment of the invention may not use a database to hold consent information. Practitioners of the art can apply our invention to such alternate embodiments also.

In an alternate embodiment of our invention, the patient visits the providers portal using a web browser. After authenticating the patient, our system presents the consent form to the user on the users screen. The patient can agree to the consent by pressing yes or decline the consent by pressing no. The system records the consent and the consent event in the CVM system.

Practitioners of the art can derive several alternate embodiments of our invention to obtain and manage patient consent in different contexts.

The illustrations, and block diagrams of FIGS. 1 and 2 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

What is claimed is:

1. A system for obtaining consent for a patient procedure comprising:
a kiosk for determining a necessary consent form, for obtaining the necessary consent form, and for recording the consent.

2. The system of claim 1, wherein the kiosk obtains patient information from a healthcare information system.

3. The system of claim 2, wherein the kiosk obtains the patient information as a data file.

4. The system of claim 2, wherein the kiosk obtains the patient information via messaging.

5. The system of claim 2, wherein the kiosk obtains patient information as data files via messaging.

6. The system of claim 1, wherein the kiosk is a standalone device.

7. The system of claim 1, wherein the kiosk executes a client application and is connected to a server that executes a server application.

8. The system of claim 1, wherein the kiosk records configuration information from a healthcare provider.

9. The system of claim 1, wherein the kiosk prints the consent form.

10. The system of claim 9, wherein the kiosk records an input from a healthcare provider to initiate printing of the consent form.

11. The system of claim 1, wherein the kiosk records a consent signature electronically.

12. The system of claim 11, wherein the kiosk includes a signature capture device for recording the consent signature electronically.

13. The system of claim 11, wherein the kiosk stores the consent signature with the consent form.

14. The system of claim 1, wherein the kiosk records details of a patient encounter.

15. The system of claim 1, wherein the kiosk delivers the consent in electronic format to a backend information system of a health care provider.

16. The system of claim 1, wherein the kiosk delivers the consent in electronic format to the patient.

17. The system of claim 9, wherein the kiosk includes a scanner, wherein the scanner scans a printed and signed consent form.

18. The system of claim 1, wherein the kiosk displays the consent form and electronically records a consent signature.

19. The system of claim 18, wherein the kiosk uses cryptographic techniques to record the consent signature.

20. The system of claim 1, wherein the patient procedure is a clinical trial.

21. The system of claim 1, wherein the patient procedure is a new or experimental procedure.

22. The system of claim 1, wherein the kiosk records payment responsibility information.

23. The system of claim 1, wherein the kiosk provides patient directives.

24. The system of claim 1, wherein the consent is from a parent or guardian responsible for a patient.

25. The system of claim 1, wherein the kiosk obtains context of care from a healthcare information system and determines the necessary consent form.
